(19) United States
(12) Patent Application Publication
(10) Pub. No.: US 2026/0344951 A1
(43) Pub. Date: Nov. 5, 2026

(54) CLEANABLE WINDOW

(71) Applicant: HEZI GOLAN MIZRAHI, GIVATAYIM (IL)

(72) Inventor: HEZI GOLAN MIZRAHI, GIVATAYIM (IL)

(21) Appl. No.: 19/211,339

(22) Filed: May 19, 2025

(30) Foreign Application Priority Data
May 5, 2025 (IL) 320689

(51) Int. Cl. A47L 1/02; E06B 7/28

(52) U.S. Cl. CPC A47L 1/02; E06B 7/28

(57) ABSTRACT

A cleanable window (10), including a pane (40), a frame (44), for holding the pane (40), a first bar (18A) disposed at a first side of the pane (40), and a mechanism (54) fixed to the frame for moving the first bar (18A) in relation to the pane (40), for cleaning it.

### CROSS-REFERENCE TO RELATED APPLICATIONS

This application claims the benefit of priority from Israel Patent Application No. 320689, filed May 5, 2025, the disclosure of which is incorporated herein by reference.

### TECHNICAL FIELD

The invention relates to the field of windows for being cleaned.

### BACKGROUND

Windows of high buildings or from exterior and interior windows, their cleaning is performed, using equipment connected outside the building.

This equipment that cleans only the outside is installed outside the building and is usually used for all or most of the exterior windows in the building. This equipment requires that the installation and connection to the building be carried out jointly by all tenants; a tenant who wants to clean only his windows cannot use the established systems that endanger human life.

FIG. 1 is a front view of a prior art stationary window.

A prior art window includes a frame 44 fixed to the structure 42. Frame 44 includes profiles, for together holding a pane 40.

However, it is difficult to clean pane 40, especially its outside.

There is a long felt need to provide a solution to the above-mentioned and other problems of the prior art.

### SUMMARY

A cleanable window, including:
a pane;
a frame, for holding the pane;
a bar disposed at a first side of the pane; and
a mechanism fixed to the frame, for moving the first bar (18A) in relation to the pane (40), for cleaning it.

### BRIEF DESCRIPTION OF THE DRAWINGS

Embodiments, features, and aspects of the invention are described herein in conjunction with the following drawings in which:

FIG. 1 is a front view of a prior art stationary window;

FIG. 2 is a front view of a stationary window according to one embodiment of the invention;

FIG. 3 is the front view of FIG. 1 at a different position of the movable bar;

FIG. 4 is a side view of the window of FIG. 2;

FIG. 5 enlarges the right angled gear of FIG. 2; and

FIG. 6 is the side view of the window of FIG. 2, including a water system.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

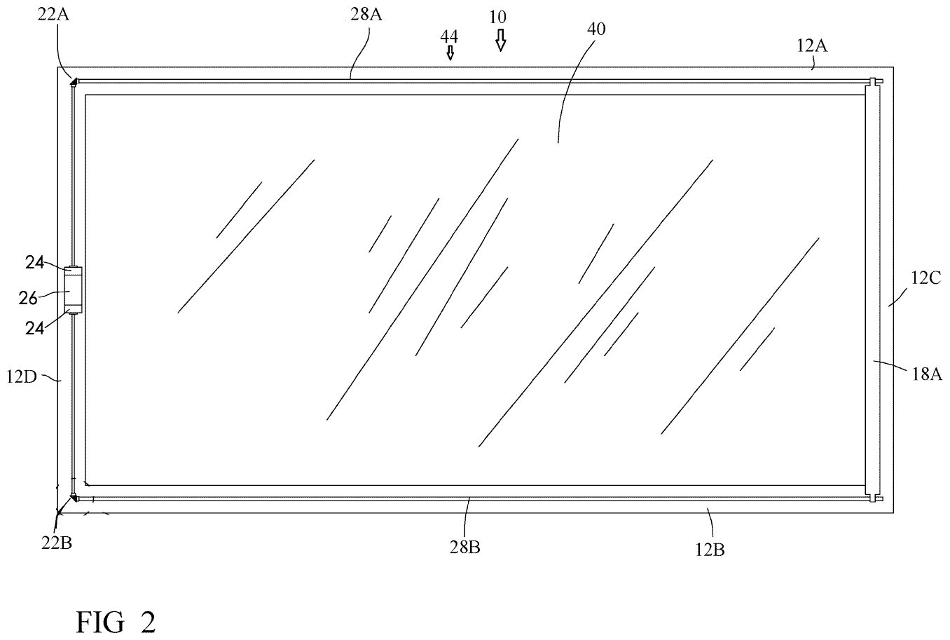

FIG. 2 is a front view of a stationary window according to one embodiment of the invention.

A cleanable window 10 according to one embodiment includes frame 44 being fixed to structure 42 or slideable in relation thereto. Frame 44 includes profiles 12A, 12B, 12C, and 12D. Side profiles 12C and 12D only hold pane 40.

Frame 44 further includes a movable bar 18A, moving in relation to pane 40 for cleaning it. While not cleaning, movable bar 18A is disposed near or attached to profile 12C.

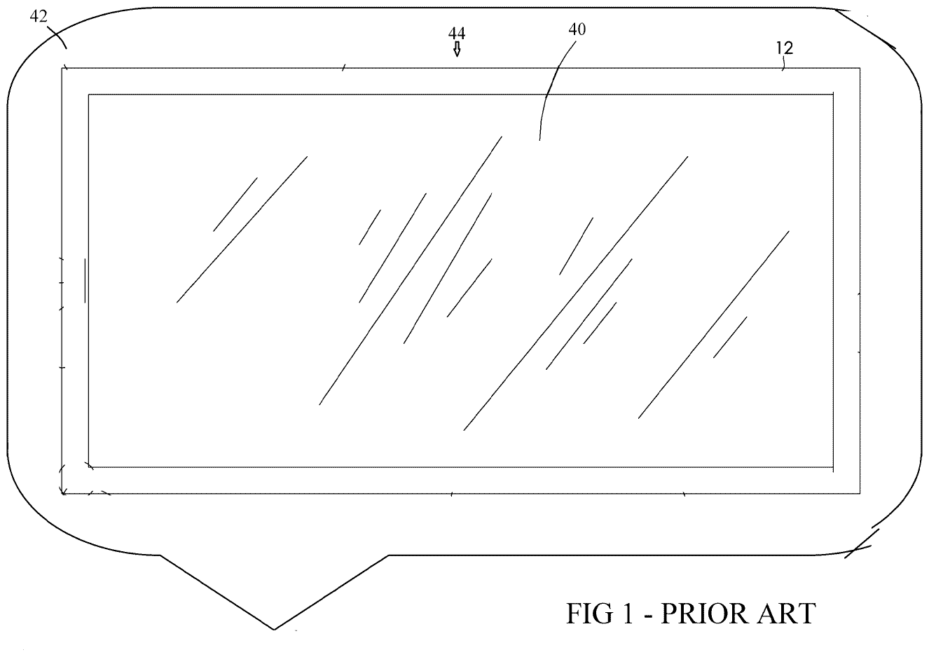

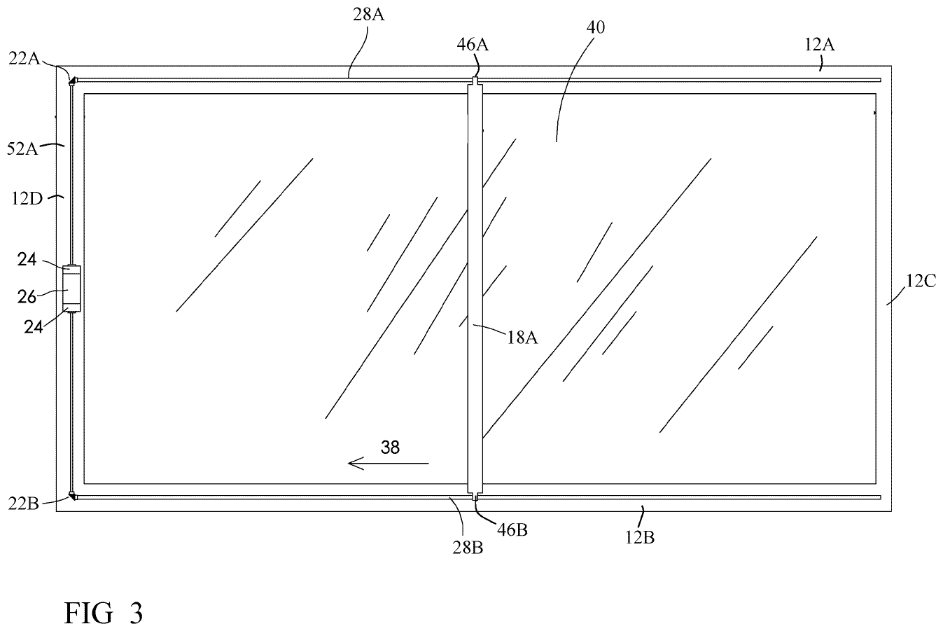

FIG. 3 is the front view of FIG. 1 at a different position of the movable bar.

Cleaning pane 40 is applied by moving (38) movable bar 18A away from profile 12C.

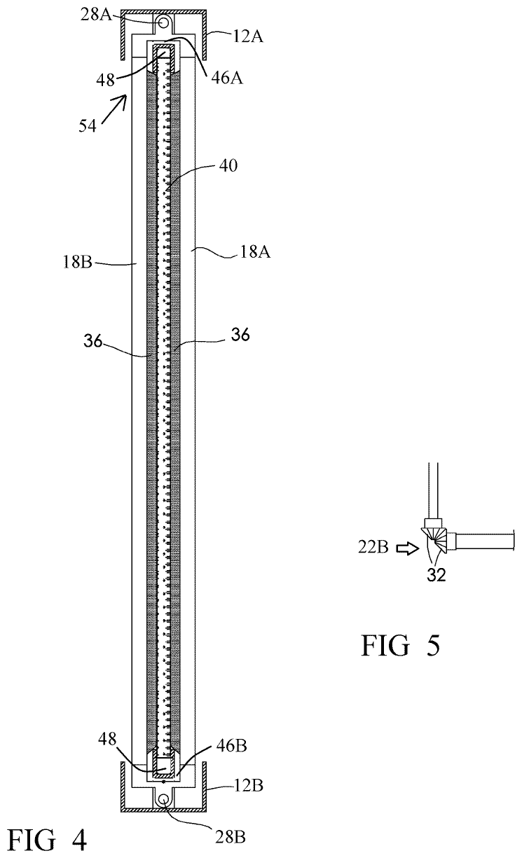

FIG. 4 is a side view of the window of FIG. 2.

Frame 44 further includes a movable bar 18B disposed at the other side of pane 40. Each of movable bars 18A and 18A includes a brushing element 36.

A hidden mechanism 54 moves the viewable bars to face each other at any position thereof. Bars 18A and 18B are fixed one to the other by a top fixing element 46A, for being fixed at the top end of pane 40, and by a bottom fixing element 46B. A thread 28A housed in profile 12A, upon being rotated, moves fixing element 46A; and a thread 28B housed in profile 12B, upon being rotated, moves fixing element 46B.

Thus, rotation of threads 28A and 28B move bars 18A, and 18B and fixing elements 46A and 46B, and brushing elements 36, all in relation to pane 40, which is fixed to profiles 12C and 12D (FIG. 4). Gap 48 between fixing element 46A and pane 40 illustrates that fixing element 46A is movable in relation to pane 40.

Referring again to FIG. 2, a motor 26 rotates a rod 52A, which rotates thread 28A through a right angled gear 22A. Motor 26 rotates a rod 52B, which rotates thread 28B through a right angled gear 22B. Thus, motor 26 rotates threads 26AA and 26B equally.

FIG. 5 enlarges the right angled gear of FIG. 2.

Right angled gear 22A includes two interlaced 45 degrees gears.

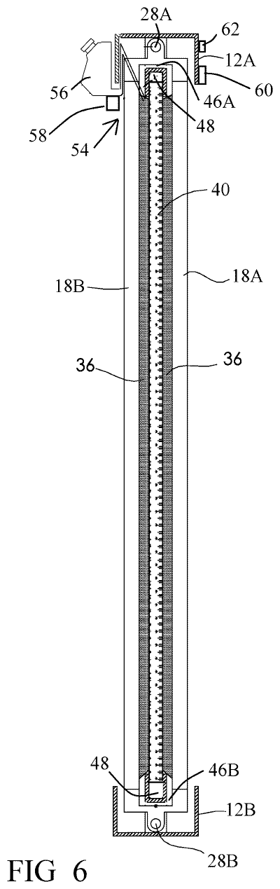

FIG. 6 is the side view of the window of FIG. 2, including a water system.

A water compartment 56 and a water pump 58 may be added for pressing water into brushes 36.

Cleanable window may include a built-in water or cleaning fluid tank integrated within the device body. It may further include a spraying system, including a nozzle or outlet pipe for liquid dispersion; and control over the spray amount or timing (manually or automatically). The window may a sensor 62, such as a temperature sensor, to avoid activation under extreme heat or cold conditions; a humidity sensor, for detecting condensation or rain and adjusting; a transparency/dirt sensor, to detect dirt level on the glass and trigger targeted cleaning; edge/boundary sensors, to prevent the system from slipping off the frame or track.

It may include a solar panel 60 embedded in the device; autonomous charging of the internal battery; independent operation without external electricity connection. It may include remote control via mobile app, including scheduling, status monitoring, and error reports; removable water tank with magnetic/smart locking for easy maintenance; dry-wipe or drying mode-optional non-liquid cleaning using vibration or suction.

Thus, in one aspect, the invention is directed to a cleanable window (10), including:
a pane (40);
a frame (44), for holding the pane (40);
a first bar (18A) being disposed outside the frame (44) at a first side of the pane (40);
a mechanism (54) housed within the frame (44), for moving the first bar (18A) along the pane (40), for cleaning it.

The window (10) may further include:
a second bar (18B) disposed at a second side of the pane (40),
wherein the mechanism is for moving the second bar (18B) along the pane (40), for cleaning it.

The mechanism (54) may include:
a fixing element (46A) housed in the frame (44) for fixing the first bar (18A) to the second bar (18B) at a first end of the pane (40).

The mechanism (54) may include:
a thread (28A) housed in the frame (44), for moving a first end of the first bar (18A) in relation to a first end of the pane (40).

The mechanism (54) may include:
a first thread (28A) housed in the frame (44), for moving a first end of the first bar (18A) and a first end of the second bar (18B), both together in relation to the pane (40).

The mechanism (54) may further include:
a second thread (28B) housed in the frame (44), for moving a first end of the first bar (18A) and a first end of the second bar (18B) together in relation to the pane (40).

The mechanism (54) may further include:
a motor (26) housed in the frame (44), for motorizibly rotating the first (28A) and second (28B) threads together.

The mechanism (54) may further include:
a first right angled gear (22A) housed in the frame (44) interlaced with the first thread (28A);
a second right angled gear (22B) housed in the frame (44) interlaced with the second thread (28A); and
a motor (26) housed in the frame (44), for motorizibly rotating the first (22A) and second (22B) right angled gears together.

In the figures and description herein, the following reference numbers (Reference Signs List) have been mentioned:
number 10 denotes the cleanable window according to one embodiment of the invention;
12A,12B,12C,12D: profiles forming frame 44;
18A,18B: bars for including brushes;
22A,22B: right angled conversion gears;
24: gear
26: motor;
28A,28B: rotatable threadings;
36: brush or rubber or other cleaning element;
38: moving of bars 18A and 18B;
40: pane;
42: building structure;
44: frame;
46A,46B: fixing elements for fixing bar 18A to bar 18B;
48: gap;
54: mechanism;
56: water compartment;
58: water pump;
60: solar panel.

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A cleanable window (10), comprising:
a pane (40);
a frame (44), for holding said pane (40);
a first bar (18A) being disposed outside said frame (44) at a first side of said pane (40);
a mechanism (54) housed within said frame for moving said first bar (18A) along said pane (40), for cleaning it.

2. The window (10) according to claim 1, further comprising:
a second bar (18B) disposed at a second side of said pane (40),
wherein said mechanism is for moving said second bar (18B) along said pane (40), for cleaning it.

3. The window (10) according to claim 2, wherein said mechanism (54) comprises:
a fixing element (46A) housed in said frame for fixing said first bar (18A) to said second bar (18B) at a first end of said pane (40).

4. The window (10) according to claim 2, wherein said mechanism (54) comprises:
a thread (28A) housed in said frame for moving a first end of said first bar (18A) in relation to a first end of said pane (40).

5. The window (10) according to claim 3, wherein said mechanism (54) comprises:
a first thread (28A) housed in said frame for moving a first end of said first bar (18A) and a first end of said second bar (18B), both together in relation to said pane (40).

6. The window (10) according to claim 5, wherein said mechanism (54) further comprises:
a second thread (28B) housed in said frame for moving a first end of said first bar (18A) and a first end of said second bar (18B) together in relation to said pane (40).

7. The window (10) according to claim 6, wherein said mechanism (54) further comprises:
a motor (26) housed in said frame for motorizibly rotating said first (28A) and second (28B) threads together.

8. The window (10) according to claim 6, wherein said mechanism (54) further comprises:
a first right angled gear (22A) housed in said frame interlaced with said first thread (28A);
a second right angled gear (22B) housed in said frame (44) interlaced with said second thread (28A); and
a motor (26) housed in said frame for motorizibly rotating said first (22A) and second (22B) right angled gears together.
